(19) United States
(12) Patent Application Publication
(10) Pub. No.: US 2025/0307727 A1
(43) Pub. Date: Oct. 2, 2025

(54) CONTROL DEVICE, CONTROL METHOD, AND COMPUTER-READABLE STORAGE MEDIUM

(71) Applicant: HONDA MOTOR CO.,LTD., Tokyo (JP)

(72) Inventor: Andrii PYDIN, Saitama (JP)

(21) Appl. No.: 18/619,196

(22) Filed: Mar. 28, 2024

(51) Int. Cl. G06Q 10/04

(52) U.S. Cl. CPC G06Q 10/04

(57) ABSTRACT

SOLUTION TO PROBLEM: A control apparatus acquires (i) information indicating the operation plan which indicates a stop time period or a number of stops for a work machine at each of a plurality of locations at which a power-feeding device can be arranged, or (ii) information indicating an actual value of the stop time period or the number of stops of the work machine at each of the plurality of locations, and, based on the information acquired by the acquisition unit, (a) decides a location, among the plurality of locations, at which the power-feeding device should be arranged, and performs control to output information indicating the location decided, or (b) perform control to output information for deciding a location, among the plurality of locations, at which the power-feeding device should be arranged.

### BACKGROUND

### 1. Technical Field

The present invention relates to a control apparatus, a control method and a computer-readable storage medium.

### 2. Related Art

Patent Document 1 describes a technique by which “resource consumption of a work vehicle at a specific work place is more appropriately estimated, and resource replenishment timing is appropriately calculated”. Patent Document 2 describes that “charging of a storage battery on a vehicle is performed, using an external power supply if a charge amount supplied from a plurality of charging apparatuses per unit time is equal to or less than a predetermined charge amount, and using the external power supply and an electrical power supply unit in a system if the charge amount exceeds the predetermined charge amount. Patent Document 3 describes that “a battery delivery plan of a road port is developed . . . based on a transportation plan of a vehicle and an electrical power transportation exchange standard of the vehicle.”

### PRIOR ART DOCUMENT

### Patent Document

Patent Document 1: WO 2017/195395
Patent Document 2: Japanese Patent Application Publication No. 2015-89266
Patent Document 3: Japanese Patent Application Publication No. 2023-51851

### SUMMARY

According to a first aspect of the present invention, there is provided a control apparatus. The control apparatus comprises a first acquisition unit that acquires (i) information indicating an operation plan for a work machine which indicates at least one of a stop time period or a number of stops of the work machine at each of a plurality of locations at which a power-feeding device which feeds power to the work machine traveling on electrical power can be arranged, or (ii) information indicating an actual value of at least one of a stop time period or a number of stops of the work machine at each of the plurality of locations. The control apparatus comprises a control unit that based on the information acquired by the first acquisition unit (a) decides a location, among the plurality of locations, at which the power-feeding device should be arranged, and performs control to output information indicating the location decided, or (b) performs control to output information for deciding a location, among the plurality of locations, at which the power-feeding device should be arranged.

In the above-described control apparatus, the control unit may perform control to decide a location, among the plurality of locations, at which the power-feeding device should be arranged, and output information indicating the location decided, based on the information acquired by the first acquisition unit.

In any of the above-described control apparatuses, the first acquisition unit may acquire information indicating an operation plan for the work machine which indicates at least one of a stop time period or a number of stops of the work machine at each of the plurality of locations at which the power-feeding device can be arranged.

In any of the above-described control apparatuses, the first acquisition unit may acquire information indicating an operation plan for the work machine which indicates at least one of a stop time period or a number of stops of the work machine at each of the plurality of locations at which the power-feeding device can be arranged.

In any of the above-described control apparatuses, the first acquisition unit may acquire (i) information indicating the operation plan for each of the plurality of work machines, or (ii) information indicating an actual value of at least one of a stop time period or a number of stops of each of the plurality of work machines at each of the plurality of locations. The control unit may decide a location, among the plurality of locations, at which the power-feeding device should be arranged based on the information acquired by the first acquisition unit.

In any of the above-described control apparatuses, the control unit may identify a consecutive period during which at least any of the plurality of work machines stops at each of the plurality of locations based on the information acquired by the first acquisition unit and decide a location, among the plurality of locations, at which the power-feeding device should be arranged based on a length of the period identified.

In any of the above-described control apparatuses, the first acquisition unit may acquire information indicating an operation plan for the work machine which indicates a stop time period and a number of stops of the work machine at each of the plurality of locations.

In any of the above-described control apparatuses, based on a stop time period and a number of stops of the work machine at each of the plurality of locations indicated by the operation plan, the control unit may calculate, for each of the plurality of locations, an evaluation value as a location at which the power-feeding device is to be arranged, and based on the evaluation value, the control unit may preferentially decide a location with the evaluation value that is higher, among the plurality of locations, to be the location at which the power-feeding device should be arranged.

In any of the above-described control apparatuses, the control unit may calculate a product of a stop time period and a number of stops of the work machine at each of the plurality of locations, and preferentially decide a location with the product value that is higher, among the plurality of locations, to be the location at which the power-feeding device should be arranged.

In any of the above-described control apparatuses, the power-feeding device may include an electric accumulator. The control unit may decide a location, among the plurality of locations, where a stop time period of the work machine is shorter than a predetermined time period as well as a number of stops of the work machine is more than a predetermined number of times, to be the location at which the power-feeding device should be arranged.

In any of the above-described control apparatuses, the power-feeding device may include an electric generator. The control unit may decide a location, among the plurality of locations, where a stop time period of the work machine is equal to or longer than a predetermined time period, to be the location at which the electric generator should be arranged.

In any of the above-described control apparatuses, the power-feeding device may include a first kind of power-feeding device including an electric accumulator and a second kind of power-feeding device including an electric generator. The control unit may decide a location, among the plurality of locations, where a stop time period of the work machine is shorter than a predetermined time period as well as a number of stops of the work machine is more than a predetermined number of times, to be the location at which the first kind of power-feeding device should be arranged. The control unit may decide a location, among the plurality of locations, where a stop time period of the work machine is equal to or longer than the predetermined time period, to be the location at which the second kind of power-feeding device should be arranged.

In any of the above-described control apparatuses, the control unit may decide a location, among the plurality of locations, where a stop time period of the work machine is shorter than the predetermined time period as well as a number of stops of the work machine is equal to or fewer than the predetermined number of times, to be the location at which neither the first kind of power-feeding device nor the second kind of power-feeding device is installed.

Any of the above-described control apparatuses may further comprise a calculation unit that calculates, based on a stop time period and a number of stops of the work machine at each of the plurality of locations indicated by the operation plan, an expected value of an amount of electrical power to be supplied to the work machine from each of the first kind of power-feeding device and the second kind of power-feeding device. The control apparatuses may comprise a second acquisition unit that acquires an actual value of an amount of electrical power supplied to the work machine from each of the first kind of power-feeding device and the second kind of power-feeding device arranged at the locations decided by the control unit. The control apparatuses may comprise an updating unit that updates at least one of the predetermined time period or the predetermined number of times based on a comparison result between the expected value of the amount of electrical power calculated by the calculation unit and the actual value of the amount of electrical power acquired by the second acquisition unit.

In any of the above-described control apparatuses, the power-feeding device may include a first kind of power-feeding device including a first kind of power supply and a second kind of power-feeding device including a second kind of power supply. The second kind of power supply may have an amount of energy loss during startup that is larger than that of the first kind of power supply and/or an amount of suppliable electrical power that is larger than that of the first kind of power supply. The control unit may decide, among the plurality of locations, a first location at which the first kind of power-feeding device should be arranged and a second location at which the second kind of power-feeding device should be arranged, based on the information acquired by the first acquisition unit.

In any of the above-described control apparatuses, the control unit may decide, among the plurality of locations, a location at which the first kind of power-feeding device should be arranged and a location at which the second kind of power-feeding device should be arranged, based on the information acquired by the first acquisition unit. The control unit may perform control to cause a display device to display a first mode of the display object on a position, in a movement path diagram indicating a movement path of the work machine, that corresponds to the location at which the first kind of power-feeding device should be arranged. The control unit may perform control to cause a display device to display a second mode of the display object on a position, in the movement path diagram, that corresponds to the location at which the second kind of power-feeding device should be arranged.

In any of the above-described control apparatuses, the first mode of the display object may be different from the second mode of the display object in shape and/or color.

According to a third aspect of the present invention, there is provided a control method. The control method comprises acquiring (i) information indicating an operation plan for a work machine which indicates at least one of a stop time period or a number of stops of the work machine at each of a plurality of locations at which a power-feeding device which feeds power to the work machine traveling on electrical power can be arranged, or (ii) information indicating an actual value of at least one of a stop time period or a number of stops of the work machine at each of the plurality of locations. The control method comprises, based on the information acquired by the acquiring, (a) deciding a location, among the plurality of locations, at which the power-feeding device should be arranged, and performing control to output information indicating the location decided, or (b) performing control to output information for deciding a location, among the plurality of locations, at which the power-feeding device should be arranged.

According to a third aspect of the present invention, there is provided a computer-readable storage medium. The computer-readable storage medium is a non-transitory computer-readable storage medium storing therein a program. The program, when executed by a computer, causes the computer to: perform acquiring (i) information indicating an operation plan for a work machine which indicates at least one of a stop time period or a number of stops of the work machine at each of a plurality of locations at which a power-feeding device which feeds power to the work machine traveling on electrical power can be arranged, or (ii) information indicating an actual value of at least one of a stop time period or a number of stops of the work machine at each of the plurality of locations. The program, when executed by a computer, causes the computer to: based on the information acquired by the acquiring, (a) decide a location, among the plurality of locations, at which the power-feeding device should be arranged, and perform control to output information indicating the location decided, or (b) perform control to output information for deciding a location, among the plurality of locations, at which the power-feeding device should be arranged.

The above-described summary of the invention does not describe all necessary features of the present invention. The present invention may also be a sub-combination of the features described above.

### BRIEF DESCRIPTION OF THE DRAWINGS

FIG. 1 illustrates a form of utilization of a system 5 according to an embodiment.

FIG. 2 schematically shows a functional block configuration of a control apparatus 100.

FIG. 3 shows a part of an operation plan for a work machine 120a.

FIG. 4 shows exemplary periods on a timeframe during which a work machine 120 stops at a node N5, a node N6, and a node N7.

FIG. 5 is a table showing stop time periods, a number of stops, and an evaluation value for each of the nodes 1 to 7.

FIG. 6 schematically shows mapping information for use in deciding candidates for nodes at which a power-feeding device 150 should be arranged.

FIG. 7 shows information stored in a first array.

FIG. 8 shows information stored in a second array.

FIG. 9 schematically shows an exemplary screen 900 displayed on a display device of a user terminal 180.

FIG. 10 is an exemplary flowchart according to a control method to be performed in the control apparatus 100.

FIG. 11 illustrates a control that a control unit 204 performs to update L1 and T1.

FIG. 12 is an exemplary flowchart according to the control method to be performed in the control apparatus 100.

FIG. 13 shows an example of a computer 2000.

### DESCRIPTION OF EXEMPLARY EMBODIMENTS

Hereinafter, the present invention will be described through embodiments of the present invention. However, the following embodiments are not for limiting the invention according to the claims. In addition, not all of the combinations of features described in the embodiments are essential to the solution of the invention.

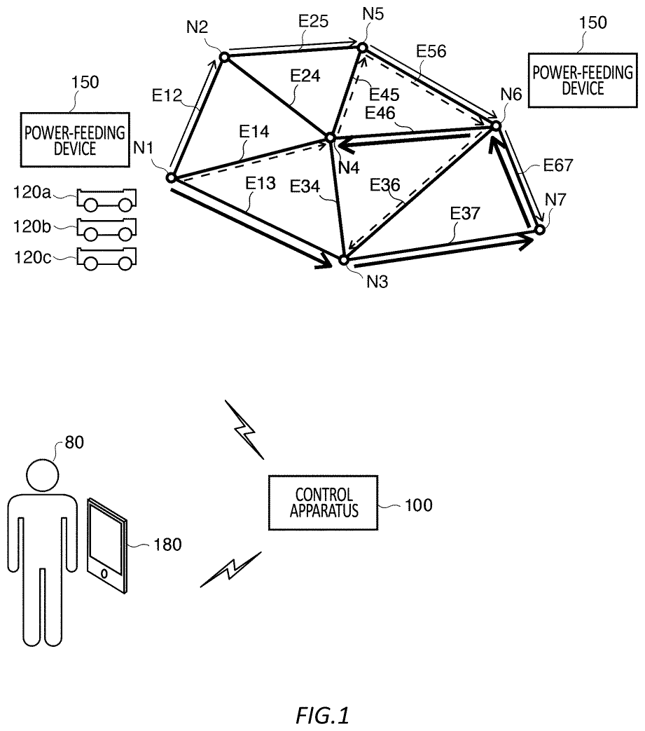

FIG. 1 illustrates a form of utilization of a system 5 according to an embodiment. The system 5 includes a control apparatus 100, a plurality of work machines including a work machine 120a, a work machine 120b, and a work machine 120c, and a user terminal 180.

A user 80 is a user of the user terminal 180. The user terminal 180 may be portable electronic equipment. The user terminal 180 may be a tablet terminal, a smartphone, a mobile phone, a notebook computer, a laptop computer, or the like. The user terminal 180 may be non-portable electronic equipment. The user terminal 180 may be a desktop personal computer or the like. The control apparatus 100 may communicate with the user terminal 180, the work machine 120, and the power-feeding device 150 through a communication network implemented by a mobile communication standard (3G, 4G, 5G, 6G, or the like), a wireless LAN, Wi-Fi (registered trademark), the Internet, or the like. At least a part of the communication network may be implemented by communication cables.

The control apparatus 100 performs control relating to a decision of a location on which the power-feeding device 150 feeding power to the work machine 120a, the work machine 120b, and the work machine 120c should be arranged.

In the present embodiment, the power-feeding device 150 is a portable power supply. However, the power-feeding device 150 may be a stationary power supply.

The power-feeding device 150 includes a first kind of power-feeding device 150 that includes an electric accumulator as a power supply. The electric accumulator is an example of the first kind of power supply. The power-feeding device 150 includes a second kind of power-feeding device 150 that includes an electric generator as a power supply. The electric generator is an example of the second kind of power supply. The electric generator may include an internal combustion engine. The electric generator may generate electricity using fuel. Exemplary fuel can include gases such as liquefied petroleum gas and natural gas, fossil fuels or synthetic fuels such as gasoline, kerosene, light oil, heavy oil, and hydrogen or the like. The electric generator may include fuel cells.

In the present embodiment, a plurality of work machines that include the work machine 120a, the work machine 120b, and the work machine 120c may be collectively referred to as a work machine 120. The work machine 120 is an example of a mobile object. In the present embodiment, the work machine 120 travels on electrical power. For example, the work machine 120 is provided with a battery to store electrical power for traveling and travels on the electrical power from the battery. The work machine 120 is a driverless vehicle that performs autonomous driving. The work machine 120 is a vehicle that performs work. As an example, the work machine 120 is a vehicle for carrying cargo.

The work machine 120 may operate at a construction site, for example. The work machine 120 may, for example, be loaded at a predetermined cargo-loading site with cargoes such as construction materials to be used in a construction site, travel to a destination of the cargoes by autonomous driving, unload the cargos at the destination of the cargoes, and then travel to a next cargo-loading site by autonomous driving.

In the present embodiment, a path along which the work machine 120 can move is defined by a plurality of nodes, each indicating a particular point, and an edge connecting the nodes. In the present embodiment, the edge connects the nodes by a straight line.

In the present embodiment, the nodes include a node N1, a node N2, a node N3, a node N4, a node N5, a node N6, and a node N7. The edges include an edge E12 connecting the node N1 and the node N2, an edge E13 connecting the node N1 and the node N3, an edge E14 connecting the node N1 and the node N4, an edge E24 connecting the node N2 and the node N4, an edge E25 connecting the node N2 and the node N5, an edge E34 connecting the node N3 and the node N4, an edge E36 connecting the node N3 and the node N6, an edge E37 connecting the node N3 and the node N7, an edge E45 connecting the node N4 and the node N5, an edge E46 connecting the node N4 and the node N6, an edge E56 connecting the node N5 and the node N6, and an edge E67 connecting the node N6 and the node N7.

In the present embodiment, the control apparatus 100 decides an operation plan for a work machine 120. The control apparatus 100 decides the operation plan for the work machine 120 based on a construction plan indicating a construction site, a scheduled construction period, the weight and size of cargoes to be carried by the work machine 120, or the like. The operation plan includes a time to depart from each node and a time to arrive at each node in a day.

As shown by an arrow of a thin solid line in FIG. 1, the work machine 120a travels, after departing from the node N1, along a movement path which runs through the node N2, the node N5, and the node N6 to the node N7 by moving sequentially along the edge E12, the edge E25, the edge 56 and the edge 67. As shown by an arrow of a broken line in FIG. 1, the work machine 120b moves, after departing from the node N1, along a movement path which runs through the node N4, the node N5, and the node N6 to the node N3 by moving sequentially along the edge E14, the edge 45, the edge 56 and the edge 36. As shown by an arrow of a thick solid line in FIG. 1, the work machine 120c moves, after departing node from the node N1, along a movement path which runs through the node N3, the node N7, and the node N6 to the node N4 by moving sequentially along the edge E13, the edge 37, the edge 67 and the edge 36.

The control apparatus 100 calculates a number of stops, which is a number of times that a work machine 120 stops at each node, based on the operation plan for the work machine 120. Also, the control apparatus 100 calculates a stop time period, which is a period of time during which the work machine 120 stops at each node, based on the operation plan for the work machine 120.

Based on at least one of the stop time period or the number of stops, the control apparatus 100 (a) decides a node, among the plurality of nodes, at which the power-feeding device 150 should be arranged, and performs control to output information indicating the decided node. For example, the control apparatus 100 causes the user terminal 180 to display a position of the node at which the power-feeding device 150 should be arranged, decided by the control apparatus 100.

Based on at least one of the stop time period or the number of stops, the control apparatus 100 may (b) perform control to output information for deciding a node, among the plurality of nodes, at which the power-feeding device 150 should be arranged. Exemplary “information for deciding a node at which the power-feeding device 150 should be arranged” can include information indicating priorities to arrange the power-feeding device 150 on each node, or information indicating effect to be achieved by arranging the power-feeding device 150 on each node, and so on. The control apparatus 100 may cause the user terminal 180 to display the information for deciding a node at which the power-feeding device 150 should be arranged.

After construction has started, the control apparatus 100 transmits, to the work machine 120, each operation plan in a day for the work machine 120. The work machine 120 autonomously travels according to the received operation plan to move between the nodes. When the operation plan is changed, the control apparatus 100 may (a) decide a node, among the plurality of nodes, at which the power-feeding device 150 should be arranged, and perform control to output information indicating the decided node, based on the changed operation plan. The control apparatus 100 may (b) perform control to output information for deciding a node, among the plurality of nodes, at which the power-feeding device 150 should be arranged, based on the changed operation plan.

After construction has started, the control apparatus 100 may acquire actual value information indicating an actual value of at least one of the stop time period or the number of stops of the work machine 120 at each of the plurality of nodes. The control apparatus 100 may (a) decide a node, among the plurality of nodes, at which the power-feeding device 150 should be arranged, and perform control to output information indicating the decided node, based on at least one of the stop time period or the number of stops indicated by the actual value information. The control apparatus 100 may (b) perform control to output information for deciding a node, among the plurality of nodes, at which the power-feeding device 150 should be arranged, based on at least one of the stop time period or the number of stops indicated by the actual value information.

After construction has started, the control apparatus 100 may acquire, from the power-feeding device 150 or the work machine 120, an actual value of an amount of electrical power supplied from the power-feeding device 150 to the work machine 120. The control apparatus 100 may decide a position on which the power-feeding device 150 should be arranged, based on a comparison result between the actual value of the amount of electrical power supplied from the power-feeding device 150 to the work machine 120 and an expected value of the amount of electrical power to be supplied from the power-feeding device 150 to the work machine 120, calculated based on the operation plan for the work machine 120.

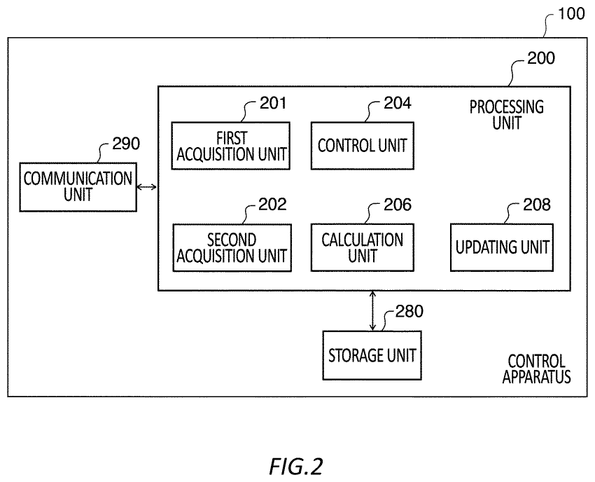

FIG. 2 schematically shows a functional block configuration of a control apparatus 100. The control apparatus 100 includes a processing unit 200, a storage unit 280, and a communication unit 290.

The processing unit 200 is implemented, for example, by an arithmetic processing apparatus including a processor. The storage unit 280 is implemented by including at least a computer-readable storage medium. The processing unit 200 performs processing using information such as programs stored in the storage unit 280. The processing unit 200 or the control apparatus 100 as a whole may be implemented by a computer that includes a CPU, a ROM, a RAM, an I/O, a bus, and the like.

The processing unit 200 includes a first acquisition unit 201, a second acquisition unit 202, a control unit 204, a calculation unit 206, and an updating unit 208.

The first acquisition unit 201 acquires (i) information indicating an operation plan for a work machine 120 which indicates at least one of a stop time period or a number of stops of the work machine 120 at each of a plurality of locations at which a power-feeding device 150 which feeds power to the work machine 120 traveling on electrical power can be arranged, or (ii) information indicating an actual value of at least one of the stop time period or the number of stops of the work machine 120 at each of the plurality of locations. Based on the information acquired by the first acquisition unit 201, the control unit 204 (a) decides a location, among the plurality of locations, at which the power-feeding device 150 should be arranged, and performs control to output information indicating the decided location, or (b) performs control to output information for deciding a location, among the plurality of locations, at which the power-feeding device 150 should be arranged.

In this way, a location at which the power-feeding device 150 should be installed can be selected based on the stop time period and the number of stops of the work machine 120 at each of the plurality of locations. Thus, for example, it becomes easier to install the power-feeding device 150 at a location where the operational efficiency of the power-feeding device 150 becomes high.

Based on the information acquired by the first acquisition unit 201, the control unit 204 may perform control to decide a location, among the plurality of locations, at which the power-feeding device 150 should be arranged, and output information indicating the decided location. The first acquisition unit 201 may acquire information indicating an operation plan for the work machine 120 which indicates at least one of a stop time period or a number of stops of the work machine 120 at each of the plurality of locations at which a power-feeding device 150 can be arranged. The first acquisition unit 201 may acquire information indicating an operation plan for the work machine 120 which indicates the stop time period or the number of stops of the work machine 120 at each of the plurality of locations.

The first acquisition unit 201 may acquire (i) information indicating an operation plan for each of the plurality of work machines 120, or (ii) information indicating an actual value of at least one of the stop time period or the number of stops of each of the plurality of work machines 120 at each of the plurality of locations, and the control unit 204 may decide a location, among the plurality of locations, at which the power-feeding device 150 should be arranged, based on the information acquired by the first acquisition unit 201.

Based on the information acquired by the first acquisition unit 201, the control unit 204 identifies a consecutive period during which at least any of the plurality of work machines 120 stops at each of the plurality of locations and decides a location, among the plurality of locations, at which the power-feeding device 150 should be arranged, based on a length of the identified period.

Based on the stop time period and the number of stops of the work machine 120 at each of the plurality of locations indicated by the operation plan, the control unit 204 may calculate, for each of the plurality of locations, an evaluation value as a location at which the power-feeding device 150 is to be arranged, and based on the evaluation value, the control unit 204 may preferentially decide a location having a higher evaluation value, among the plurality of locations, to be the location at which the power-feeding device 150 should be arranged. The control unit 204 may calculate a product of the stop time period and the number of stops of the work machine 120 at each of the plurality of locations, and may preferentially decide a location having a higher product value, among the plurality of locations, to be the location at which the power-feeding device 150 should be arranged. The “product” is an example of the evaluation value. The evaluation value may be calculated using the stop time period and the number of stops along with any predetermined function.

In this way, it is possible to arrange the power-feeding device 150 taking into account the stop time period and the number of stops of the work machine 120. Thus, the power-feeding device 150 can be arranged, for example, at a location where the work machine 120 is to be fed with power more frequently and/or a location where a period during which the work machine 120 can be fed with power is expected to become longer. In this way, a determination can be made efficiently about where to arrange the power-feeding device 150 even if the power-feeding device 150 cannot be installed at all locations where the work machine 120 may stop. In addition, the operational efficiency of the power-feeding device 150 can be enhanced.

The first acquisition unit 201 may acquire information indicating an operation plan for a work machine 120 which indicates at least one of a stop time period or a number of stops of the work machine 120 at each of the plurality of locations at which the power-feeding device 150 can be arranged.

The power-feeding device 150 may include an electric accumulator. In this case, the control unit 204 may decide a location, among the plurality of locations, where a stop time period of the work machine 120 is shorter than a predetermined time period as well as a number of stops of the work machine 120 is more than a predetermined number of times, to be the location at which the power-feeding device 150 should be arranged. The power-feeding device 150 may include an electric generator. In this case, the control unit 204 may decide a location, among the plurality of locations, where a stop time period of the work machine 120 is equal to or longer than the predetermined time period, to be the location at which the electric generator should be arranged.

The power-feeding device 150 may include a first kind of power-feeding device 150 including the electric accumulator and a second kind of power-feeding device 150 including the electric generator. In this case, the control unit 204 may decide a location, among the plurality of locations, where a stop time period of the work machine 120 is shorter than the predetermined time period as well as a number of stops of the work machine 120 is more than the predetermined number of times, to be the location at which the first kind of power-feeding device 150 should be arranged, and may decide a location, among the plurality of locations, where a stop time period of the work machine 120 is equal to or longer than the predetermined time period, to be the location at which the second kind of power-feeding device 150 should be arranged.

The control unit 204 may decide a location, among the plurality of locations, where a stop time period of the work machine 120 is shorter than the predetermined time period as well as a number of stops of the work machine 120 is equal to or fewer than the predetermined number of times, to be the location at which neither the first kind of power-feeding device 150 nor the second kind of power-feeding device 150 is installed.

The power-feeding device 150 includes the first kind of power-feeding device 150 including a first kind of power supply and a second kind of power-feeding device 150 including the second kind of power supply. The second kind of power supply has an amount of energy loss during startup that is larger than that of the first kind of power supply and/or an amount of suppliable electrical power that is larger than that of the first kind of power supply. In this case, the control unit 204 decides, among the plurality of locations, a first location at which the first kind of power-feeding device 150 should be arranged and a second location at which the second kind of power-feeding device 150 should be arranged, based on the information acquired by the first acquisition unit 201. In this way, it is possible to arrange the power-feeding device 150 at a location in which power feeding suitable to the kind of the power-feeding device 150 is expected to be demanded, taking into account the characteristics (an amount of energy loss during startup and/or an amount of suppliable electrical power) of a power-feeding device 150.

Based on the stop time period and the number of stops of a work machine 120 at each of the plurality of locations indicated by the operation plan, the calculation unit 206 calculates an expected value of an amount of electrical power to be supplied to the work machine 120 from each of the first kind of power-feeding device 150 and the second kind of power-feeding device 150. The second acquisition unit 202 acquires an actual value of the amount of electrical power supplied to the work machine 120 from each of the first kind of power-feeding device 150 and the second kind of power-feeding device 150 arranged at the locations decided by the control unit 204. The updating unit 208 updates at least one of a predetermined time period or a predetermined number of times based on a comparison result between the expected value of the amount of electrical power calculated by the calculation unit 206 and the actual value of the amount of electrical power acquired by the second acquisition unit 202.

Based on the information acquired by the first acquisition unit 201, the control unit 204 may decide, among the plurality of locations, a location at which the first kind of power-feeding device 150 should be arranged and a location at which the second kind of power-feeding device 150 should be arranged, perform control to cause a display device to display a first mode of the display object on a position, in a movement path diagram indicating a movement path of the work machine 120, that corresponds to the location at which the first kind of power-feeding device 150 should be arranged, and perform control to cause a display device to display a second mode of the display object on a position, in the movement path diagram, that corresponds to the location at which the second kind of power-feeding device 150 should be arranged. The first mode of the display object may be different from the second mode of the display object in shape and/or color.

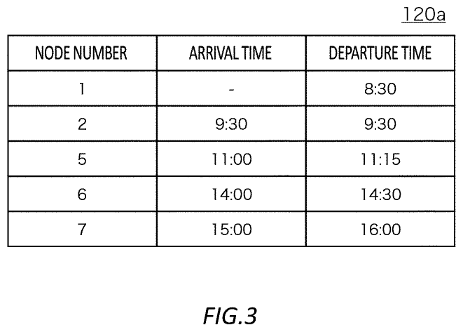

FIG. 3 shows a part of an operation plan for the work machine 120a. The operation plan includes node numbers, arrival times, and departure times as data items. In FIG. 3, node numbers 1, 2, 3, 4, 5, 6, and 7 represent node N1, node N2, node N3, node N4, node N5, node N6, and node N7, respectively.

Based on the information indicating the operation plan, the first acquisition unit 201 identifies that the work machine 120a passes through the node N2 after departing from the node 1 and arrives at the node N5 at 11:00, stops at the node N5 for 15 minutes, arrives at the node N6 at 14:00 after departing from the node N5, stops at the node N6 for 30 minutes, arrives at the node N7 at 15:00 after departing from the node N6, and stops at the node N7 for 60 minutes. In this manner, the first acquisition unit 201 acquires nodes at which the work machine 120a stops, the times at which it arrives at these nodes, and the stop time periods during which it stops at these nodes.

Similarly, based on the operation plan for each of the work machine 120b and the work machine 120c, the first acquisition unit 201 acquires the nodes at which the work machine 120 stops, the times at which it arrives at these nodes, and the stop time periods during which it stops at these nodes, for each of the work machine 120b and the work machine 120c.

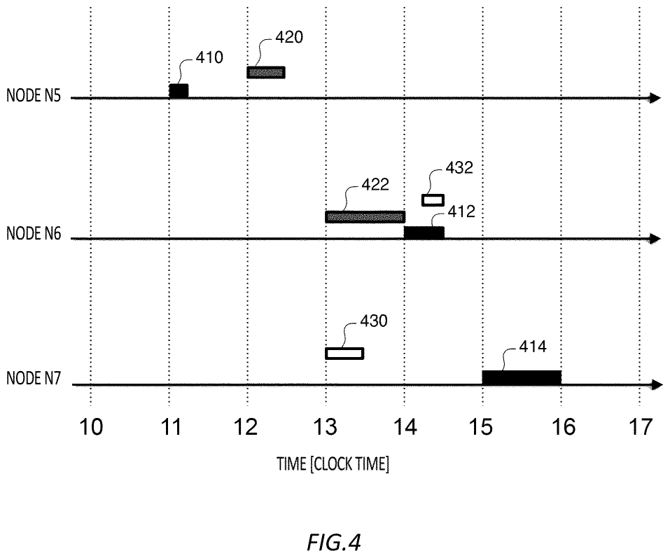

FIG. 4 shows exemplary periods on a timeframe during which a work machine 120 stops at the node N5, the node N6, and the node N7. The reference numbers 410, 412, and 414 indicate periods during which the work machine 120a stops at the node N5, the node N6 and the node N7, respectively. The reference numbers 420 and 422 indicate periods during which the work machine 120b stops at the node N5 and the node N6, respectively. The reference numbers 430 and 432 indicate periods during which the work machine 120c stops at the node N7 and the node N6, respectively.

Based on the nodes at which the work machine 120 stops, the times at which it arrives at these nodes, and the stop time periods during which it stops at these nodes for each of the work machines 120, acquired by the first acquisition unit 201, the control unit 204 determines that the number of times at least any of the work machines 120 stops at the node 5 is two, and the consecutive period during which at least any of the work machines 120 stops at the node 5 is 30 minutes. Here, if there are multiple periods during which at least any of the work machines 120 stops at the node 5, the control unit 204 sets the longest period among the multiple periods as the stop period.

Similarly, based on the nodes at which the work machine 120 stops, the times at which it arrives at these nodes, and the stop time periods during which it stops at these nodes for each of the work machines 120, acquired by the first acquisition unit 201, the control unit 204 determines that the number of times at least any of the work machines 120 stops at the node 6 is three, and the consecutive period during which at least any of the work machines 120 stops at the node 6 is 90 minutes. Similarly, the based on the nodes at which the work machine 120 stops, the times at which it arrives at these nodes, and the stop time periods during which it stops at these nodes for each of the work machines 120, acquired by the first acquisition unit 201, the control unit 204 determines that the number of times at least any of the work machines 120 stops at the node 7 is two, and the consecutive period during which at least any of the work machines 120 stops at the node 7 is 60 minutes.

In this manner, the first acquisition unit 201 acquires the information indicating the operation plan for each of the plurality of work machines 120, and based on the information acquired by the first acquisition unit 201, the control unit 204 identifies the consecutive periods during which at least any of the plurality of work machines 120 stops at each of the plurality of nodes. As will be described below, the control unit 204 decides a node, among the plurality of nodes, at which the power-feeding device 150 should be arranged, based on a length of the identified period.

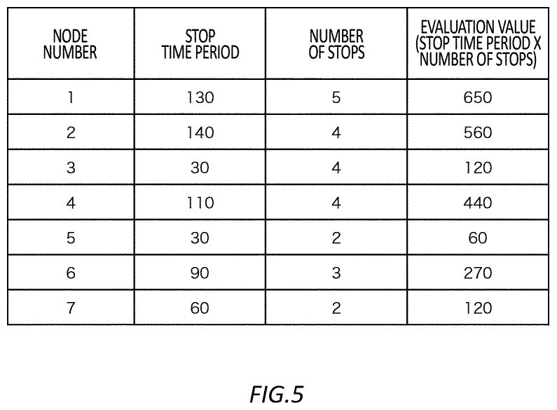

FIG. 5 is a table showing stop time periods, a number of stops, and an evaluation value for each of the nodes 1 to 7.

The stop time period indicates a consecutive period identified by the control unit 204, during which at least any of the plurality of work machines 120 stops at each node. indicates a number of times, identified by the control unit 204, that at least any of the work machines 120 stops at each node.

The evaluation value indicates a degree of suitability for each in the plurality of nodes as a location at which the power-feeding device 150 should be arranged. In the present embodiment, the evaluation value is calculated by a product of a stop time period and a number of stops. In other embodiments, the evaluation value may be calculated based on at least one of a stop time period or a number of stops, using any predetermined function. The usage of the evaluation value will be described below.

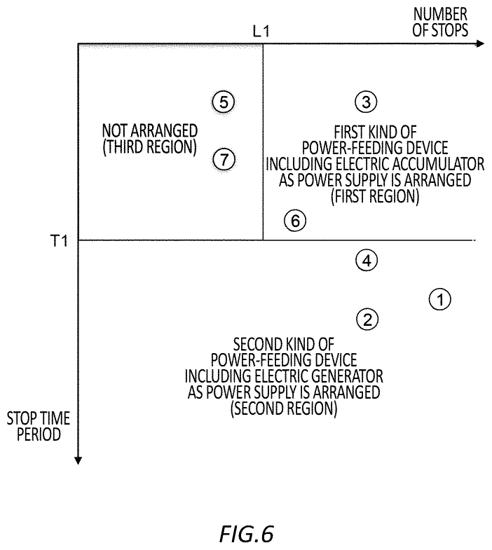

FIG. 6 schematically shows mapping information for use in deciding candidates for nodes at which a power-feeding device 150 should be arranged. In the mapping information, the stop time periods and the number of stops at each node are mapped in any of a first region, a second region, and a third region that are specified by two axes of a stop time period and a number of stops. Using the mapping information, the control unit 204 maps the nodes in any of the first region, second region, and the third region, based on the stop time periods and the number of stops at each node.

The first region, the second region, and the third region are defined by a predetermined time period relating to the stop time period (sometimes referred to as time period T, time period T1, time period T2 and the like), and a predetermined number of times relating to the number of stops (sometimes referred to as number of times L, number of times L1, number of times L2 and the like).

Specifically, as shown in FIG. 6, a node having a stop time period shorter than the predetermined time period T1 and a number of stops more than the predetermined number of times L1 is mapped in the first region. The control unit 204 determines that the node mapped in the first region is a candidate for a node at which the first kind of power-feeding device 150 including a storage battery as a power supply is to be arranged. In the example of FIG. 6, the node N3 and the node N6 are mapped in the first region.

The node having a stop time period equal to or longer than T1 is mapped in the second region. The control unit 204 determines that the node mapped in the second region is a candidate for a node at which the second kind of power-feeding device 150 including an electric generator as a power supply is to be arranged. In the example of FIG. 6, the node N1, the node N2, and the node N6 are mapped in the second region.

The node having a stop time period shorter than T1 and a number of stops equal to or fewer than L1 is mapped in the third region. The control unit 204 determines that the node mapped in the third region is not a candidate for a node at which the power-feeding device 150 is arranged. In the example of FIG. 6, the node N5 and the node N7 are mapped in the third region. In this manner, the control unit 204 decides the node, among the plurality of nodes, where a stop time period of the work machine 120 is shorter than the predetermined time period as well as a number of stops of the work machine 120 is equal to or fewer than the predetermined number of times, to be a location at which neither the first kind of power-feeding device 150 nor the second kind of power-feeding device 150 is to be installed.

The control unit 204 stores, in a first array, a combination of a node number and an evaluation value of the node mapped in the first region, and stores, in a second array, a combination of a node number and an evaluation value of the node mapped in the second region.

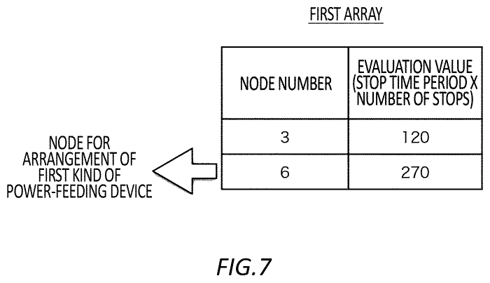

FIG. 7 shows information stored in the first array. As shown in FIG. 7, a record of the node number and the evaluation value of the node N3 and a record of the node number and the evaluation value of the node N7 are stored in the first array.

The control unit 204 sorts the records in the first array according to the levels of the evaluation values, selects a maximum of M records in descending order of the evaluation values, and decides the nodes indicated by the node numbers of the selected records to be the nodes at which the first kind of power-feeding device 150 should be arranged. Here, M is the maximum number of the first kind of power-feeding devices 150 that can be provided as the power-feeding device 150 capable of feeding power to the work machine 1. FIG. 7 shows an example in which M=1. In this case, the control unit 204 decides the node N6 to be the node at which the first kind of power-feeding device 150 should be arranged.

In this manner, the control unit 204 decides the node, among the plurality of nodes, where a stop time period of the work machine 120 is shorter than the predetermined time period as well as the number of stops of the work machine 120 is more than the predetermined number of times, to be a node at which the first kind of power-feeding device 150 including the electric accumulator should be arranged. Specifically, the control unit 204 calculates a product of the stop time period and the number of stops of the work machine 120 at each of the plurality of nodes and preferentially decides a node having a higher product value, among the plurality of nodes, to be the node at which the power-feeding device 150 should be arranged.

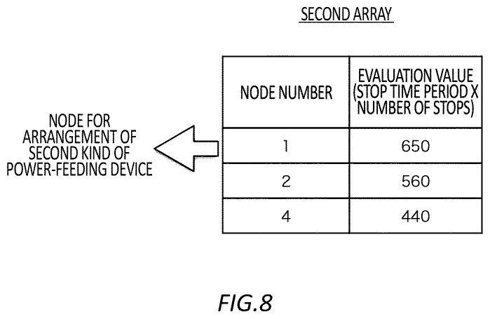

FIG. 8 shows information stored in the second array. As shown in FIG. 8, a record of the node number and the evaluation value of the node N1 and a record of the node number and the evaluation value of the node N7 are stored in the second array.

The control unit 204 sorts the records in the second array according to the levels of the evaluation values, selects a maximum of N records in descending order of the evaluation values, and decides the nodes indicated by the node numbers of the selected records to be the nodes at which the second kind of power-feeding device 150 should be arranged. Here, N is the maximum number of the second kind of power-feeding devices 150 that can be provided as the power-feeding device 150 capable of feeding power to the work machine 1. FIG. 8 shows an example in which N=1. In this case, the control unit 204 decides the node N1 to be the node at which the second kind of power-feeding device 150 should be arranged.

Specifically, based on the stop time period and the number of stops of the work machine 120 at each of the plurality of nodes indicated by the operation plan, the control unit 204 calculates the evaluation value for each of the plurality of nodes as a node at which the power-feeding device 150 is to be arranged, and based on the evaluation value, the control unit 204 preferentially decides a node having a higher evaluation value, among the plurality of nodes, to be the node at which the power-feeding device 150 should be arranged.

In this manner, the control unit 204 decides the node, among the plurality of nodes, where a stop time period of the work machine 120 is equal to or longer than the predetermined time period, to be a node at which the second kind of power-feeding device 150 including the electric generator should be arranged.

In general, the amount of energy loss during startup of electric generators is larger than the amount of energy loss during startup of electric accumulators. Accordingly, an electric generator causes a larger amount of energy loss by repeatedly starting or stopping, compared to an electric, and it is desirable to continuously operate an electric generator as long as possible. Moreover, electric generators typically have a larger amount of suppliable electrical power compared to electric accumulators. Thus, an electric generator can supply electrical power for a longer period compared to an electric accumulator. Accordingly, it is desirable to arrange the second kind of power-feeding device 150 including the electric generator at a node where a stop time period of the work machine 120 is longer.

The control unit 204 decides a node, among the plurality of nodes, where a stop time period of the work machine 120 is shorter than the predetermined time period as well as a number of stops of the work machine 120 is more than the predetermined number of times, to be the first node at which the first kind of power-feeding device 150 should be arranged, and decides a node, among the plurality of nodes, where a stop time period of the work machine 120 is equal to or longer than the predetermined time period, to be the second node at which the second kind of power-feeding device 150 should be arranged. In this way, the amount of energy loss caused by repeatedly starting and stopping the electric generator can be expected to decrease.

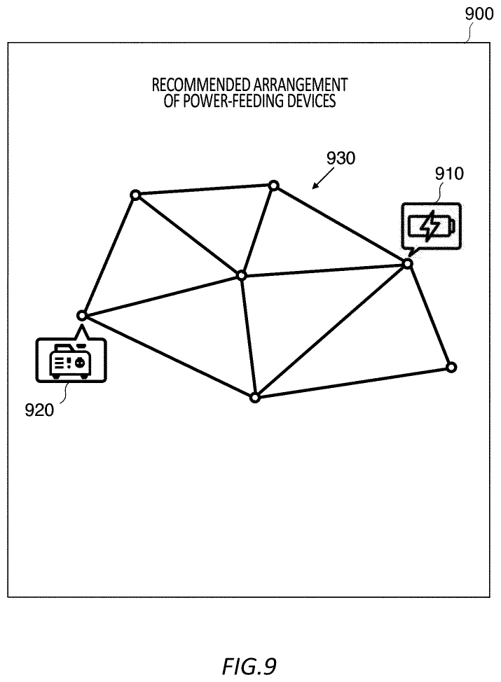

FIG. 9 schematically shows an exemplary screen 900 displayed on a display device of a user terminal 180. The screen 900 includes a display object 910, a display object 920, and a display object 930.

The display object 930 shows a diagram of movement paths along which the work machine 120 can move. The display object 910 shows a position in the display object 930 of a node at which the first kind of power-feeding device 150 should be arranged. The display object 920 shows a position in the display object 930 of a node at which the second kind of power-feeding device 150 should be arranged.

The control unit 204 performs control to transmit, to the user terminal 180 through the communication unit 290, movement path information indicating paths along which the work machine 120 can move, coordinate information indicating a position of a node at which the first kind of power-feeding device 150 should be arranged, and coordinate information indicating a position of a node at which the second kind of power-feeding device 150 should be arranged. In this way, the user terminal 180 displays the screen 900. The movement path information may include, for example, the coordinate information indicating a position of each node and edge information indicating nodes connected by each edge.

In the example of FIG. 9, the display object 910 is an icon displayed near the node N6, and the display object 920 is an icon displayed near the node N1. The shape of the display object 910 is different from the shape of the display object 920. In this way, the user 80 can easily recognize which kind of power-feeding device 150 is to be arranged at each node on the movement map. Thus, work efficiency for the user 80 can be enhanced.

The example of FIG. 9 exemplifies a situation in which the shape of the display object 910 is different from the shape of the display object 920. The shape of the display object is an example of a mode of the display object. As a mode of the display object, a color of the display object can be exemplified. As a mode of the display object, a shape and color of the display object can be exemplified.

In this manner, based on the information acquired by the first acquisition unit 201, the control unit 204 decides, among the plurality of nodes, a node at which the first kind of power-feeding device 150 should be arranged and a node at which the second kind of power-feeding device 150 should be arranged, performs control to cause the display device of the user terminal 180 to display the first mode of the display object 910 at a position, in the movement path diagram indicating the movement path of a work machine 120, that corresponds to the location at which the first kind of power-feeding device 150 should be arranged, and performs control to cause the display device of the user terminal 180 to display the second mode of the display object 920 at a position, in a display object 930, that corresponds to the location at which the second kind of power-feeding device 150 should be arranged.

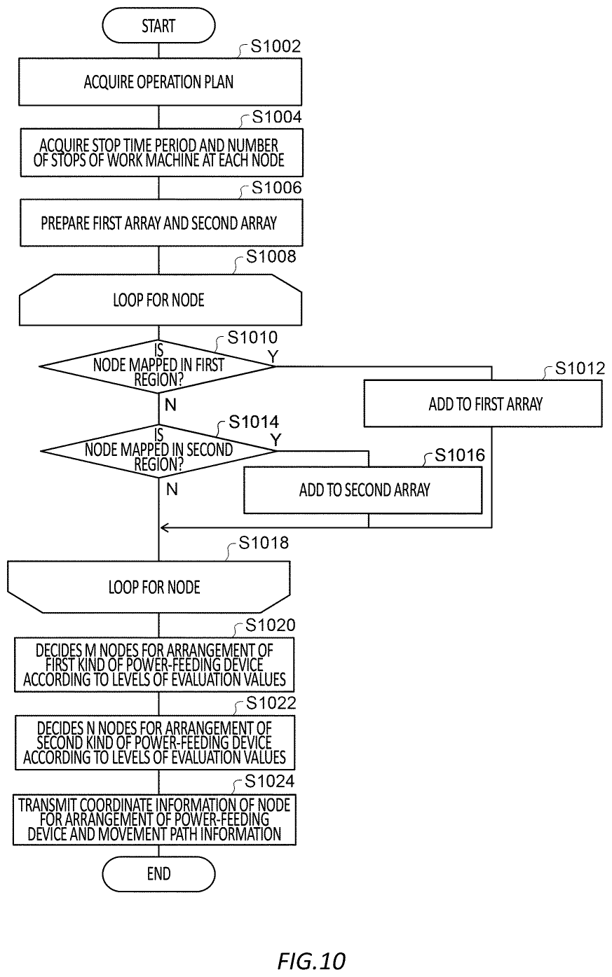

FIG. 10 is an exemplary flowchart according to a control method to be performed in the control apparatus 100. The processing of this flowchart starts, for example, when an instruction to request for nodes at which the power-feeding device 150 should be arranged is received from the user terminal 180.

In S1002, the first acquisition unit 201 acquires an operation plan for a work machine 120. The operation plan may be an operation plan previously created by the control apparatus 100. For example, the first acquisition unit 201 may acquire an operation plan stored in the storage unit 280. The first acquisition unit 201 may acquire an operation plan received from an external server through the communication unit 290.

In S1004, the control unit 204 acquires a stop time period and a number of stops of the work machine 120 at each node. Based on the operation plan acquired in S1002, the control unit 204 acquires the stop time period and the number of stops of the work machine 120 at each node. Specifically, the stop time period and the number of stops of the work machine 120 at each node are calculated by a method described in connection with FIG. 3, FIG. 4, and FIG. 5 and the like.

In S1006, the control unit 204 prepares the first array and the second array. Then, the control unit 204 performs loop processing relating to nodes shown by S1008 to S1018. The control unit 204 performs processing shown in S1010 to S1016 by loop processing for each node.

In S1010, based on the stop time period and the number of stops of the work machine 120 at the node identified in S1004, the control unit 204 determines whether the node is to be mapped in the first region. Specifically, the control unit 204 uses the mapping information described in connection with FIG. 6 and the like to determine whether the node is to be mapped in the first region. When it is determined that the node is to be mapped in the first region, the control unit 204 adds a record including the node number and the evaluation value to the first array in S1012.

In S1014, based on the stop time period and the number of stops of the work machine 120 at the node identified in S1004, the control unit 204 determines whether the node is to be mapped in the second region. Specifically, the control unit 204 uses the mapping information described in connection with FIG. 6 and the like to determine whether the node is to be mapped in the second region based on the stop time period of the work machine 120. When it is determined that the node is to be mapped in the second region, the control unit 204 adds a record including the node number and the evaluation value to the second array in S1016.

When the loop processing ends, in S1020, the control unit 204 refers to the record included in the first array and decides M nodes at which the first kind of power-feeding device 150 should be arranged, according to the levels of the evaluation values.

Then, in S1022, the control unit 204 refers to the record included in the second array and decides N nodes at which the second kind of power-feeding device 150 should be arranged, according to the levels of the evaluation values.

In S1024, the control unit 204 performs control to output the coordinate information of each of the M nodes, decided in S1020, at which the first kind of power-feeding device 150 should be arranged and N nodes, decided in S1022, at which the second kind of power-feeding device 150 should be arranged, and the movement path information. For example, the control unit 204 controls the communication unit 290 to cause the user terminal 180 to transmit the coordinate information and the movement path information.

As described above, the first acquisition unit 201 acquires the information indicating the operation plan for the work machine 120 which indicates the stop time period and the number of stops of the work machine 120 at each of the plurality of nodes at which the power-feeding device 150 which feeds power to the work machine 120 can be arranged. Based on the information acquired by the first acquisition unit 201, the control unit 204 performs control to decide the node, among the plurality of nodes, at which the power-feeding device 150 should be arranged, and output information indicating the decided node.

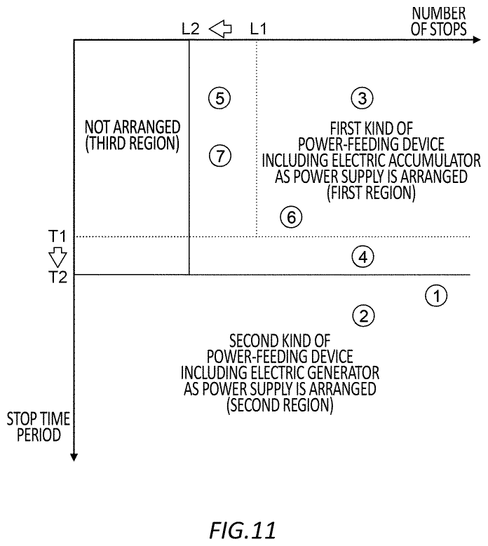

FIG. 11 illustrates a control that the control unit 204 performs to update L1 and T1. After the nodes at which each of the first kind of power-feeding device 150 and the second kind of power-feeding device 150 should be arranged are decided, the power-feeding devices 150 are arranged at the decided nodes, and operation of the work machine 120 starts. After the operation of the work machine 120 has started, the second acquisition unit 202 acquires an actual value of the amount of electrical power supplied to the work machine 120 from each of the power-feeding devices 150 arranged at the nodes decided by the control unit 204.

Meanwhile, the calculation unit 206 calculates an expected value of the amount of electrical power to be supplied to the work machine 120 from each of the power-feeding devices 150, based on the stop time period and the number of stops of the work machine 120 at each of the plurality of nodes. The updating unit 208 updates the time period T1 and the number of times L1 based on a comparison result between the expected value of the amount of electrical power calculated by the calculation unit 206 and the actual value of the amount of electrical power acquired by the second acquisition unit 202.

Specifically, the updating unit 208 updates the time period T1 and the number of times L1 if the difference between the expected value of the amount of electrical power calculated by the calculation unit 206 and the actual value of the amount of electrical power acquired by the second acquisition unit 202 is larger than the predetermined value. For example, the updating unit 208 updates the time period T1 to the time period T2 by changing the time period T1 by a predetermined value, and updates the number of times L1 to the number of times L2 by changing the number of times L1 by a predetermined value.

For example, in the example shown in FIG. 11, the node N4 of excluded from the candidates at which the second kind of power-feeding device 150 is to be arranged, and the node N4, the node N5, and the node N7 are added to the candidates at which the first kind of power-feeding device 150 is to be arranged. The control unit 204 newly decides a node at which the power-feeding device 150 should be arranged based on the changed time period T2 and the number of times L2.

Subsequently, the power-feeding device 150 is moved to a point corresponding to the node, which was newly decided by the control unit 204, at which the power-feeding device 150 should be arranged. In this way, the arrangement of the power-feeding device 150 may be changed. Then, the work machine 120 restarts the operation.

After the work machine 120 has been operated for a predetermined time period, the second acquisition unit 202 acquires an actual value of the amount of electrical power supplied to the work machine 120 from each of the power-feeding devices 150 arranged at the nodes decided by the control unit 204. The second acquisition unit 202 may acquire the actual value of the amount of electrical power from the power-feeding device 150. The second acquisition unit 202 may acquire the actual value of the amount of electrical power from the work machine 120.

The calculation unit 206 calculates an expected value of the amount of electrical power to be supplied to the work machine 120 from each of the power-feeding devices 150 based on the stop time period and the number of stops of the work machine 120 at each of the plurality of nodes. The updating unit 208 maintains T2 and L2 without updating them if the difference between the expected value of the amount of electrical power calculated by the calculation unit 206 and the actual value of the amount of electrical power acquired by the second acquisition unit 202 is equal to or smaller than the predetermined value.

On the other hand, the updating unit 208 updates T2 and L2 again if the difference between the expected value of the amount of electrical power calculated by the calculation unit 206 and the actual value of the amount of electrical power acquired by the second acquisition unit 202 is larger than the predetermined value. As an example, if the difference between the expected value of the amount of electrical power calculated by the calculation unit 206 and the actual value of the amount of electrical power acquired by the second acquisition unit 202 in a situation where a predetermined time period T and number of times L are set to T2 and L2, respectively, is larger than the difference between the expected value of the amount of electrical power calculated by the calculation unit 206 and the actual value of the amount of electrical power acquired by the second acquisition unit 202 in a situation where a predetermined time period T and number of times L set to T1 and L1, respectively, the updating unit 208 brings the predetermined time period T and the predetermined number of times L closer to T1 and L1. On the other hand, if the difference between the expected value of the amount of electrical power calculated by the calculation unit 206 and the actual value of the amount of electrical power acquired by the second acquisition unit 202 in a situation where a predetermined time period T and number of times L are set to T2 and L2, respectively, is smaller than the difference between the expected value of the amount of electrical power calculated by the calculation unit 206 and the actual value of the amount of electrical power acquired by the second acquisition unit 202 in a situation where a predetermined time period T and number of times L set to T1 and L1, respectively, the updating unit 208 updates the predetermined time period T and the predetermined number of times L in a direction to bring them further away from T1 and L1.

By repeating the above operations, it can be expected that the predetermined time period T and number of times L used to decide the nodes at which the first power-feeding device 150 should be arranged and the nodes at which the second kind of power-feeding device 150 should be arranged, are set as appropriate values based on the actual values of the amount of electrical power supplied to the work machines 120 from the power-feeding devices 150.

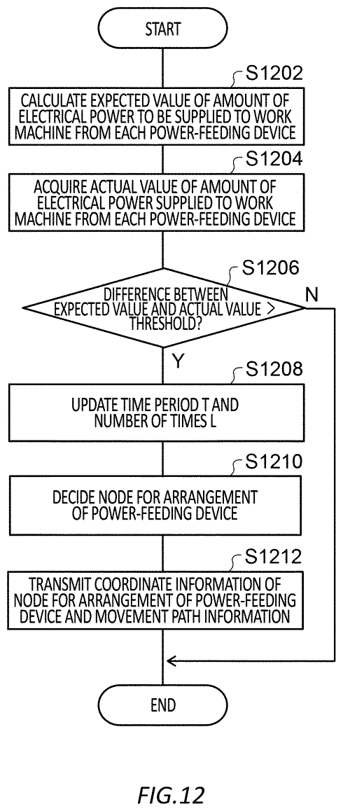

FIG. 12 is an exemplary flowchart according to the control method to be performed in the control apparatus 100. The processing of this flowchart may start, for example, when an instruction to update the predetermined time period T and number of times L is received from the user terminal 180. The processing of this flowchart may start, for example, at every passage of a predetermined time period.

In S1202, the calculation unit 206 calculates an expected value of the amount of electrical power to be supplied to the work machine 120 from each of the power-feeding devices 150 based on the stop time period and the number of stops of the work machine 120 at each of the plurality of nodes. In S1204, the second acquisition unit 202 acquires an actual value of the amount of electrical power supplied to the work machine 120 from each of the power-feeding devices 150 arranged at the nodes decided, by the control unit 204, to be the nodes at which the power-feeding devices 150 should be installed.

In S1206, the updating unit 208 determines whether a difference between the expected value of the amount of electrical power calculated in S1202 and the actual value of the amount of electrical power acquired in S1204 is larger than a predetermined threshold. If the updating unit 208 determines that the difference between the expected value of the amount of electrical power calculated in S1202 and the actual value of the amount of electrical power acquired in S1204 is equal to or smaller than the predetermined threshold, the processing of this flowchart ends.

If the updating unit 208 determines that the difference between the expected value of the amount of electrical power calculated in S1202 and the actual value of the amount of electrical power acquired in S1204 is larger than the predetermined threshold, the updating unit 208 updates, in S1208, the predetermined time period T and number of times L used to decide the nodes at which the first power-feeding device 150 should be arranged and the nodes at which the second kind of power-feeding device 150 should be arranged.

Then, in S1210, the control unit 204 decides the nodes at which the first power-feeding device 150 should be arranged and the nodes at which the second kind of power-feeding device 150 should be arranged, using the time period T and the number of times L updated in S1208. For example, the control unit 204 decides the nodes at which the first power-feeding device 150 should be arranged and the nodes at which the second kind of power-feeding device 150 should be arranged by performing the processing described in connection with FIG. 3 to FIG. 8, FIG. 10, and the like.

Then, in S1212, the control unit 204 performs control to output the coordinate information of each of the nodes at which the first kind of power-feeding device 150 should be arranged and the nodes at which the second kind of power-feeding device 150 should be arranged, decided in S1210, and the movement path information.

In this manner, based on the stop time period and the number of stops of the work machine 120 at each of the plurality of nodes indicated by the operation plan, the calculation unit 206 calculates the expected value of the amount of electrical power to be supplied to the work machine 120 from each of the first kind of power-feeding device 150 and the second kind of power-feeding device 150. The second acquisition unit 202 acquires the actual value of the amount of electrical power supplied to the work machine 120 from each of the first kind of power-feeding device 150 and the second kind of power-feeding device 150 arranged at the nodes decided by the control unit 204. The updating unit 208 updates the predetermined time period or the predetermined number of times based on the comparison result between the expected value of the amount of electrical power calculated by the calculation unit 206 and the actual value of the amount of electrical power acquired by the second acquisition unit 202. In this way, it can be expected that the power-feeding devices 150 are arranged at more appropriate nodes by using the precise amount of electrical power to be supplied from the power-feeding device 150 to the work machine 120 based on the actual values. Thus, the operational efficiency of the power-feeding device 150 can be enhanced and the possible electricity shortage of the work machines 120 can be reduced.

In the embodiments described above, the “stop time period” and the “number of stops” of the work machine 120 are mainly described as the information indicated by the operation plan. However, at least one of the “stop time period” or the “number of stops” of the work machine 120 may be the stop time period or the number of stops identified based on the actual operation of the work machine 120. That is, the first acquisition unit 201 may acquire information indicating an actual value of at least one of the stop time period or the number of stops of the work machine 120 at each of the plurality of nodes. By using the actual value of the practical stop time period and/or the number of stops of the work machine 120, the location at which the power-feeding device 150 should be installed can be selected more precisely.

The “node” in the embodiments described above is an example of the location at which the power-feeding device 150 should be arranged. The location at which the power-feeding device 150 should be arranged may not only be a particular point but also a region having a certain area. For example, the location at which the power-feeding device 150 should be arranged may be a rectangular region obtained by sectioning a worksite in a grid. In this case, the “stop time period” may be defined as a time period during which the work machine 120 stops at any position in the region, and the “number of stops” may be defined as a number of times that the work machine 120 stops at any position in the region.

In the embodiments described above, the first kind of power-feeding device 150 is defined as a power-feeding device including the electric accumulation unit as a power supply and the second kind of power-feeding device 150 is defined as a power-feeding device including the electric generator as a power supply. However, a configuration can also be adopted in which the power-feeding device 150 is defined as a power-feeding device including the electric generator and the electric accumulation unit as a power supply. When adopting this configuration, the power-feeding device including the electric generator and the electric accumulation unit as a power supply may be classified as either the first kind of power-feeding device 150 or the second kind of power-feeding device 150, depending on which of the electric generator or the electric accumulation unit is used as a main power supply to feed power to the work machine 120. As an example, the power-feeding device including the electric generator and the electric accumulation unit as a power supply may be classified as either the first kind of power-feeding device 150 or the second kind of power-feeding device 150, depending on the generation capacity of the electric generator or the storage capacity of the electric accumulation unit. The power-feeding device with the storage capacity of the electric accumulation unit that is smaller than a predetermined capacity may be classified as the second kind of power-feeding device. The power-feeding device with the generation capacity of the electric generator that is smaller than a predetermined capacity may be classified as the first kind of power-feeding device.

The system 5 described above can perform control to decide the location, among the plurality of locations, at which the power-feeding device 150 should be arranged, based on at least one of the stop time period and the number of stops of the work machine 120. In this way, the power-feeding device 150 can be arranged at the location where the operational efficiency of the power-feeding device 150 becomes high. Moreover, an electricity shortage of the work machine 120 can be less likely to occur because the work machine 120 can be more frequently supplied with electrical power.

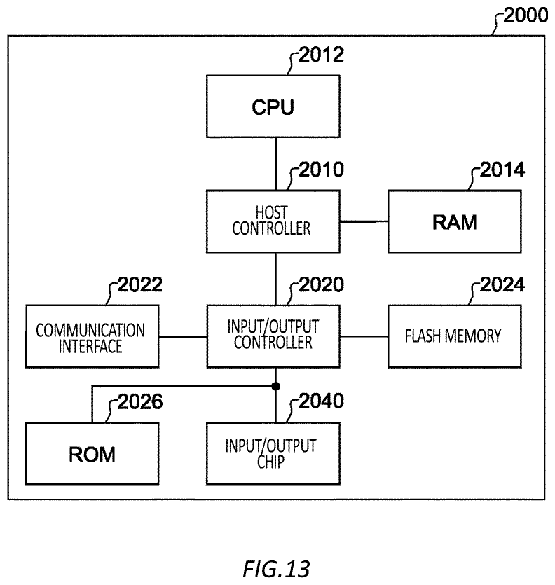

FIG. 13 shows an example of a computer 2000 in which a plurality of embodiments of the present invention may be entirely or partially embodied. A program installed in the computer 2000 can cause the computer 2000 to function as a system or each unit of the system, an apparatus such as various control apparatuses 100, or each unit of the apparatus according to the embodiment, to execute an operation associated with the system or each unit of the system, the apparatus, or each unit of the apparatus, and/or to execute a process or a stage of the process according to the embodiment. Such a program may be executed by a CPU 2012 in order to cause the computer 2000 to execute a particular operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer-readable storage medium such as a CD-ROM, a DVD-ROM, or a memory card. The RAM 2014, the ROM 2026, or the flash memory 2024 is an example of the computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. An apparatus or a method may be configured by implementing operations or processing of information depending on a use of the computer 2000.

For example, when a communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various types of processing on the data on the RAM 2014. Then, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various types of processing including various types of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, is stored in the recording medium, the CPU 2012 may retrieve an entry having a designated attribute value of the first attribute that matches a condition from these multiple entries, and read the attribute value of the second attribute stored in this entry, thereby acquiring the attribute value of the second attribute associated with the first attribute that satisfies a predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

The programs installed in the computer 2000 and causing the computer 2000 to function as the control apparatus 100 may instruct the CPU 2012 or the like to cause the computer 2000 to function as each unit of the control apparatus 100. The information processing written in these programs are read by the computer 2000 to cause the computer to function as each unit of the control apparatus 100, which is specific means realized by the cooperation of software and the various types of hardware resources described above. Then, these specific means realize calculation or processing of information corresponding to an intended use of the computer 2000 in this embodiment, so that the control apparatus 100 is constructed as a specific control apparatus corresponding to the intended use.

Various embodiments have been described with reference to the block diagrams and the like. In the block diagrams, each block may represent (1) a stage of a process in which an operation is executed, or (2) each unit of the apparatus having a role in executing the operation. A specific stage and each unit may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device. Thereby, the computer-readable storage medium having instructions stored therein forms at least a part of a product including instructions which can be executed to provide means for executing processing procedures or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), wide area network (WAN) such as the Internet, and a computer-readable instruction may be executed to provide means for executing operations specified in the described processing procedures or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the above described embodiments. It is apparent to persons skilled in the art that various alterations or improvements can be made to the above-described embodiments. It is also apparent from description of the claims that the embodiments to which such alterations or improvements are made can be included in the technical scope of the present invention.

The operations, procedures, steps, and stages etc. of each process performed by an apparatus, system, program, and method shown in the claims, specification, or diagrams can be executed in any order as long as the order is not indicated by “before”, “prior to”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

5: system;
80: user;
100: control apparatus;
120: work machine;
150: power-feeding device;
180: user terminal;
200: processing unit;
201: first acquisition unit;
202: second acquisition unit;
204: control unit;
206: calculation unit;
208: updating unit;
280: storage unit;
290: communication unit
410, 412, 414, 420, 422, 430, 432: reference numbers;
900: screen;
910, 920, 930: display object;
2000: computer;
2010: host controller;
2012: CPU;
2014: RAM;
2020: input/output controller;
2022: communication interface;
2024: flash memory;
2026: ROM;
2040: input/output chip.

1. A control apparatus, comprising:
a first acquisition unit that acquires (i) information indicating an operation plan for a work machine which indicates at least one of a stop time period or a number of stops of the work machine at each of a plurality of locations at which a power-feeding device which feeds power to the work machine traveling on electrical power can be arranged, or (ii) information indicating an actual value of at least one of a stop time period or a number of stops of the work machine at each of the plurality of locations; and
a control unit that,
based on the information acquired by the first acquisition unit,
(a) decides a location, among the plurality of locations, at which the power-feeding device should be arranged, and performs control to output information indicating the location decided, or
(b) performs control to output information for deciding a location, among the plurality of locations, at which the power-feeding device should be arranged.

2. The control apparatus according to claim 1, wherein
the control unit performs control to decide, based on the information acquired by the first acquisition unit, a location, among the plurality of locations, at which the power-feeding device should be arranged, and output information indicating the location decided.

3. The control apparatus according to claim 1, wherein
the first acquisition unit acquires information indicating an operation plan for the work machine which indicates at least one of a stop time period or a number of stops of the work machine at each of the plurality of locations at which the power-feeding device can be arranged.

4. The control apparatus according to claim 2, wherein
the first acquisition unit acquires information indicating an operation plan for the work machine which indicates at least one of a stop time period or a number of stops of the work machine at each of the plurality of locations at which the power-feeding device can be arranged.

5. The control apparatus according to claim 4, wherein
the first acquisition unit acquires (i) information indicating the operation plan for each of a plurality of the work machine, or (ii) information indicating an actual value of at least one of a stop time period or a number of stops of each of the plurality of work machines at each of the plurality of locations, and
the control unit decides a location, among the plurality of locations, at which the power-feeding device should be arranged based on the information acquired by the first acquisition unit.

6. The control apparatus according to claim 5, wherein
the control unit identifies a consecutive period during which at least any of the plurality of work machines stops at each of the plurality of locations based on the information acquired by the first acquisition unit and decides a location, among the plurality of locations, at which the power-feeding device should be arranged based on a length of the period identified.

7. The control apparatus according to claim 4, wherein
the first acquisition unit acquires information indicating an operation plan for the work machine which indicates a stop time period and a number of stops of the work machine at each of the plurality of locations.

8. The control apparatus according to claim 7, wherein
based on a stop time period and a number of stops of the work machine at each of the plurality of locations indicated by the operation plan, the control unit calculates, for each of the plurality of locations, an evaluation value as a location at which the power-feeding device is to be arranged, and based on the evaluation value, the control unit preferentially decides a location with the evaluation value that is higher, among the plurality of locations, to be a location at which the power-feeding device should be arranged.

9. The control apparatus according to claim 7, wherein
the control unit calculates a product of a stop time period and a number of stops of the work machine at each of the plurality of locations and preferentially decides a location with the product value that is higher, among the plurality of locations, to be a location at which the power-feeding device should be arranged.

10. The control apparatus according to claim 7, wherein
the power-feeding device includes an electric accumulator, and
the control unit decides a location, among the plurality of locations, where a stop time period of the work machine is shorter than a predetermined time period as well as a number of stops of the work machine is more than a predetermined number of times, to be a location at which the power-feeding device should be arranged.

11. The control apparatus according to claim 7, wherein
the power-feeding device includes an electric generator, and
the control unit decides a location, among the plurality of locations, where a stop time period of the work machine is equal to or longer than a predetermined time period, to be a location at which the electric generator should be arranged.

12. The control apparatus according to claim 6, wherein
the power-feeding device includes a first kind of power-feeding device including an electric accumulator and a second kind of power-feeding device including an electric generator, and
the control unit
decides a location, among the plurality of locations, where a stop time period of the work machine is shorter than a predetermined time period as well as a number of stops of the work machine is more than a predetermined number of times, to be a location at which the first kind of power-feeding device should be arranged, and
decides a location, among the plurality of locations, where a stop time period of the work machine is equal to or longer than the predetermined time period, to be a location at which the second kind of power-feeding device should be arranged.

13. The control apparatus according to claim 12, wherein
the control unit decides a location, among the plurality of locations, where a stop time period of the work machine is shorter than the predetermined time period as well as a number of stops of the work machine is equal to or fewer than the predetermined number of times, to be a location at which neither the first kind of power-feeding device nor the second kind of power-feeding device is installed.

14. The control apparatus according to claim 12, further comprising:
a calculation unit that calculates, based on a stop time period and a number of stops of the work machine at each of the plurality of locations indicated by the operation plan, an expected value of an amount of electrical power to be supplied to the work machine from each of the first kind of power-feeding device and the second kind of power-feeding device;
a second acquisition unit that acquires an actual value of an amount of electrical power supplied to the work machine from each of the first kind of power-feeding device and the second kind of power-feeding device arranged at the locations decided by the control unit; and
an updating unit that updates at least one of the predetermined time period or the predetermined number of times based on a comparison result between the expected value of the amount of electrical power calculated by the calculation unit and the actual value of the amount of electrical power acquired by the second acquisition unit.

15. The control apparatus according to claim 2, wherein
the power-feeding device includes a first kind of power-feeding device including a first kind of power supply and a second kind of power-feeding device including a second kind of power supply,
the second kind of power supply has an amount of energy loss during startup that is larger than that of the first kind of power supply and/or an amount of suppliable electrical power that is larger than that of the first kind of power supply, and
the control unit decides, among the plurality of locations, a first location at which the first kind of power-feeding device should be arranged and a second location at which the second kind of power-feeding device should be arranged, based on the information acquired by the first acquisition unit.

16. The control apparatus according to claim 4, wherein
the power-feeding device includes a first kind of power-feeding device including a first kind of power supply and a second kind of power-feeding device including a second kind of power supply,
the second kind of power supply has an amount of energy loss during startup that is larger than that of the first kind of power supply and/or an amount of suppliable electrical power that is larger than that of the first kind of power supply, and
the control unit decides, among the plurality of locations, a first location at which the first kind of power-feeding device should be arranged and a second location at which the second kind of power-feeding device should be arranged, based on the information acquired by the first acquisition unit.

17. The control apparatus according to claim 15, wherein
the control unit
decides, among the plurality of locations, a location at which the first kind of power-feeding device should be arranged and a location at which the second kind of power-feeding device should be arranged, based on the information acquired by the first acquisition unit,
performs control to cause a display device to display a first mode of a display object on a position, in a movement path diagram indicating a movement path of the work machine, that corresponds to the location at which the first kind of power-feeding device should be arranged, and
performs control to cause a display device to display a second mode of a display object on a position, in the movement path diagram, that corresponds to the location at which the second kind of power-feeding device should be arranged.

18. The control apparatus according to claim 17, wherein
the first mode of the display object is different from the second mode of the display object in shape and/or color.

19. A control method, comprising:
acquiring (i) information indicating an operation plan for a work machine which indicates at least one of a stop time period or a number of stops of the work machine at each of a plurality of locations at which a power-feeding device which feeds power to the work machine traveling on electrical power can be arranged, or (ii) information indicating an actual value of at least one of a stop time period or a number of stops of the work machine at each of the plurality of locations; and,
based on the information acquired by the acquiring,
(a) deciding a location, among the plurality of locations, at which the power-feeding device should be arranged, and performing control to output information indicating the location decided, or
(b) performing control to output information for deciding a location, among the plurality of locations, at which the power-feeding device should be arranged.

20. A non-transitory computer-readable storage medium storing therein a program, the program, when executed by a computer, causes the computer to:
perform acquiring (i) information indicating an operation plan for a work machine which indicates at least one of a stop time period or a number of stops of the work machine at each of a plurality of locations at which a power-feeding device which feeds power to the work machine traveling on electrical power can be arranged, or (ii) information indicating an actual value of at least one of a stop time period or a number of stops of the work machine at each of the plurality of locations; and,
based on the information acquired by the acquiring,
(a) decide a location, among the plurality of locations, at which the power-feeding device should be arranged, and perform control to output information indicating the location decided, or
(b) perform control to output information for deciding a location, among the plurality of locations, at which the power-feeding device should be arranged.
